(19) United States
(12) Patent Application Publication
(10) Pub. No.: US 2014/0112372 A1
(43) Pub. Date: Apr. 24, 2014

(54) DEVICE FOR MEASURING A TEMPERATURE OF A POWER SEMICONDUCTOR

(71) Applicants: ECPE Engineering Center for Power Electronics GmbH, Nuernberg (DE); Fraunhofer-Gesellschaft zur Foerderung der angewandten Forschung e.V., Munich (DE)

(72) Inventors: Eckart HOENE, Berlin (DE); Thomas BAUMANN, Berlin (DE); Oleg ZEITER, Berlin (DE)

(73) Assignees: ECPE Engineering Center for Power Electronics GmbH, Nuernberg (DE); Fraunhofer-Gesellschaft zur Foerderung der angewandten Forschung e.V., Munich (DE)

(21) Appl. No.: 14/140,726

(22) Filed: Dec. 26, 2013

Related U.S. Application Data
(63) Continuation of application No. PCT/EP2012/062508, filed on Jun. 27, 2012.

(30) Foreign Application Priority Data
Jun. 28, 2011 (EP) 11171699.9

(51) Int. Cl. G01K 7/01

(52) U.S. Cl. CPC G01K 7/01
USPC 374/178

(57) ABSTRACT

Embodiments of the present invention provide a device for measuring a temperature of a power semiconductor, having means for applying an alternating voltage to the power semiconductor, and means for measuring an impedance between the control terminal of the power semiconductor and the channel terminal of the power semiconductor, the impedance being dependent on a temperature-dependent control resistor integrated in the power semiconductor.

### CROSS-REFERENCE TO RELATED APPLICATIONS

This application is a continuation of copending International Application No. PCT/EP2012/062508, filed Jun. 27, 2012, which is incorporated herein by reference in its entirety, and additionally claims priority from European Application No. 11171699.9, filed Jun. 28, 2011, which is also incorporated herein by reference in its entirety.

### BACKGROUND OF THE INVENTION

Embodiments of the present invention relate to a device for measuring a temperature of a power semiconductor. Further embodiments of the present invention relate to measuring the barrier layer temperature of a power semiconductor using the temperature dependence of a series resistor integrated in the semiconductor chip.

In the publication “Time Resolved In Situ Tᵥⱼ Measurements of 6.5 kV IGBTs during Inverter Operation” by Waleri Berkel, Thomas Duetermeyer, Gunnar Puk and Oliver Schilling, four methods of measuring the barrier layer temperature of 6.5 kV IGBTs (insulated gate bipolar transistors) during inverter operation are compared to one another, which will be described below briefly.

A first method of the four known methods relates to using an IR (infrared) camera for detecting electromagnetic radiation emitted from the surface of the IGBT. Using Planck's radiation law, the surface temperature of the IGBT can be determined from the intensity of the electromagnetic radiation emitted. However, this necessitates opening the inverter for the measurement and covering the IGBT surface with a suitable material. The surface temperature, however, is only partly suitable for giving information on the barrier layer temperature, due to the thermal resistance between the barrier layer and the surface.

Using a thermo-element for measuring the barrier layer temperature of the IGBT is a second method of the four known methods. The thermo-element here is glued onto the surface of the IGBT. However, this also necessitates opening the inverter, thus making measurement in a built-in state of the inverter impossible. In addition, the time constant of thermo-elements is in the range of 200 ms so that even the temperature ripple of a 20 Hz load current can no longer be resolved.

A third method of the four known methods is based on using an IR sensor for determining the surface temperature of the IGBT. Like in the IR camera, the temperature-dependent intensity of the electromagnetic radiation emitted from the surface of the IGBT is made use of to determine the surface temperature of the IGBT. However, caused by the high time constant of IR sensors, temperature ripple cannot be resolved, in contrast to IR cameras.

A fourth method of the four known methods resorts to using the internal gate resistor of the IGBT as a sensor for measuring the barrier layer temperature. A constant current is impressed in the internal gate resistor and a voltage drop across same is measured in order to use the temperature dependence of the internal gate resistor. However, this necessitates changing the internal setup of the IGBT such that the internal gate resistor may be contacted from outside. Using a special substrate of a modified layout is necessitated for contacting the internal gate resistor from outside.

### SUMMARY

According to an embodiment, a device for measuring a temperature of a power semiconductor may have: means for applying an alternating voltage to the power semiconductor; and means for measuring an impedance between the control terminal of the power semiconductor and the channel terminal of the power semiconductor, the impedance being dependent on a temperature-dependent control resistor integrated in the power semiconductor; wherein the means for applying the alternating voltage is configured to select a frequency of the alternating voltage such that capacitive and/or inductive portions of the measurement are reduced, and such that the frequency is in a range of a resonant frequency defined by the capacitive and/or inductive portions.

According to another embodiment, a method of measuring a temperature of a power semiconductor may have the steps of: applying an alternating voltage to the power semiconductor; and measuring an impedance between the control terminal of the power semiconductor and the channel terminal of the power semiconductor, the impedance being dependent on a temperature-dependent control resistor integrated in the power semiconductor; wherein, when measuring the impedance, a frequency of the alternating voltage is selected such that capacitive and/or inductive portions of the measurement are reduced, and such that the frequency is in a range of a resonant frequency which is defined by the capacitive and/or inductive portions.

In embodiments, an alternating voltage is applied to the power semiconductor and the impedance between the control terminal of the power semiconductor and the channel terminal of the power semiconductor is measured. This impedance is dependent on the temperature-dependent control resistor integrated in the power semiconductor such that a change in temperature of the power semiconductor results in a change in the impedance between the control terminal of the power semiconductor and the channel terminal of the power semiconductor. Inventively applying an alternating voltage to the power semiconductor allows measuring the impedance without modifying the power semiconductor. Additionally, the impedance may be used in a built-in state of the power semiconductor, thereby exemplarily allowing the temperature of the power semiconductor to be measured in an inverter, without opening the inverter itself. In addition, measuring the impedance which is dependent on the temperature-dependent control resistor integrated in the power semiconductor allows measuring the temperature of the power semiconductor with high precision.

### BRIEF DESCRIPTION OF THE DRAWINGS

Embodiments of the present invention will be detailed subsequently referring to the appendage drawings, in which:

FIG. 1 shows a block circuit diagram of a device for measuring a temperature of a power semiconductor in accordance with an embodiment of the present invention;

FIG. 2 shows a block circuit diagram of a power semiconductor comprising an integrated control resistor;

FIG. 3 shows a diagram of an impedance between a gate terminal of an IGBT and an emitter terminal of the IGBT as a function of the frequency of an alternating voltage applied to the IGBT, for 12 different temperatures; and

FIG. 4 shows a block circuit diagram of a device for measuring the temperature of a power semiconductor in accordance with an embodiment of the present invention.

### DETAILED DESCRIPTION OF THE INVENTION

In the following description of embodiments of the invention, same elements or elements of equal effect are provided with the same reference numerals in the figures such that the description thereof in the different embodiments is mutually exchangeable.

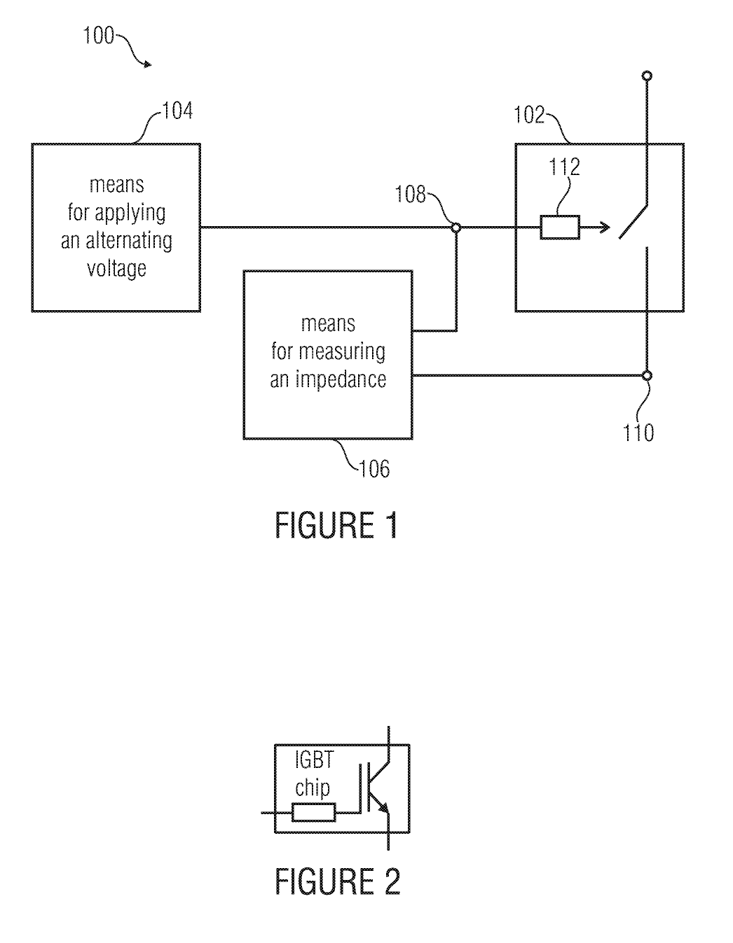

FIG. 1 shows a block circuit diagram of a device 100 for measuring a temperature of a power semiconductor 102 in accordance with an embodiment of the present invention. The device 100 comprises means 104 for applying an alternating voltage to the power semiconductor 102 and means 106 for measuring an impedance between a control terminal 108 of the power semiconductor 102 and a channel terminal 110 of the power semiconductor 102, the impedance being dependent on a temperature-dependent control resistor 112 integrated in the power semiconductor 102.

In embodiments, an alternating voltage is applied to the power semiconductor 102 and the impedance between the control terminal 108 of the power semiconductor 102 and the channel terminal 110 of the power semiconductor 102 is measured. The impedance here is dependent on the temperature-dependent control resistor 112 integrated in the power semiconductor. A change in the temperature of the power semiconductor 102 consequently results in a change in the impedance between the control terminal 108 of the power semiconductor 102 and the channel terminal 110 of the power semiconductor 102. In embodiments, the integrated control resistor 112 has a known, for example material-dependent, temperature dependence such that same may be used for determining the temperature of the power semiconductor 102.

The means 106 for measuring the impedance may additionally be configured to determine the temperature of the power semiconductor 102 on the basis of the impedance. Due to the fact that the control resistor 112 is integrated in the power semiconductor 102, the temperature of the power semiconductor 102 can be measured with high precision. Additionally, the integrated control resistor 112 usually is arranged in direct proximity to the barrier layer of the power semiconductor 102, thus allowing a highly precise determination of the barrier layer temperature of the power semiconductor 102.

The means 104 for applying the alternating voltage may be configured to apply the alternating voltage between the control terminal 108 of the power semiconductor 102 and the channel terminal 110 of the power semiconductor 102.

The power semiconductor 102 may comprise parasitic capacities and/or inductivities between the control terminal 108 and the channel terminal 110. Additionally, the means 104 for applying the alternating voltage and the means 106 for measuring the impedance may be coupled or connected to the power semiconductor 102 via feeds which also comprise inductivities.

The means 106 for measuring the impedance thus may be configured to determine the temperature of the power semiconductor 102 based on a real part of the impedance.

In order to reduce the capacitive and/or inductive portions of the measurement, the means 104 for applying the alternating voltage may be configured to select a frequency of the alternating voltage such that the capacitive and/or inductive portions of the measurement are reduced. Exemplarily, the means 104 for applying the alternating voltage may be configured to select the frequency of the alternating voltage such that the frequency is in a range of a resonant frequency defined by the capacitive and/or inductive portions. Thus, the capacitive portions may include capacities of the power semiconductor 102, and the inductive portions may include inductivities of the power semiconductor 102. Additionally, the capacitive portions may include capacities of the means 104 for applying the alternating voltage and/or the means 106 for measuring the impedance, and the inductive portions may include inductivities of the means 104 for applying the alternating voltage and/or the means 106 for measuring the impedance.

In embodiments, the power semiconductor 102 may be a bipolar transistor 102 or an IGBT 102, wherein, in the case of the IGBT 102, the control resistor 112 is a gate resistor 112, the control terminal 108 is a gate terminal 108 and the channel terminal 110 is an emitter terminal 110. Gate resistors 112 (or gate series resistors) exhibiting a temperature dependence are integrated in power semiconductors 102 (in particular in IGBTs).

Embodiments of the present invention describe a method using which the gate resistor 112 may be measured and, thus, the temperature of the power semiconductor 102 may be determined, without having to modify commercially available structures of the power semiconductor 102. Measurement may take place during normal operation of the power semiconductor 102. In accordance with the invention, a sinusoidal alternating voltage is fed between the gate terminal 108 and the emitter terminal 110, the frequency of which is selected such that a gate capacity and feed inductivities become resonant and the impedances thereof cancel each other out.

An embodiment of the present invention in which the power semiconductor 102, as is shown in FIG. 2, is an IGBT 102 will be described below. However, the following description may also be applied to different power semiconductors 102 which comprise an integrated temperature-dependent control resistor 112.

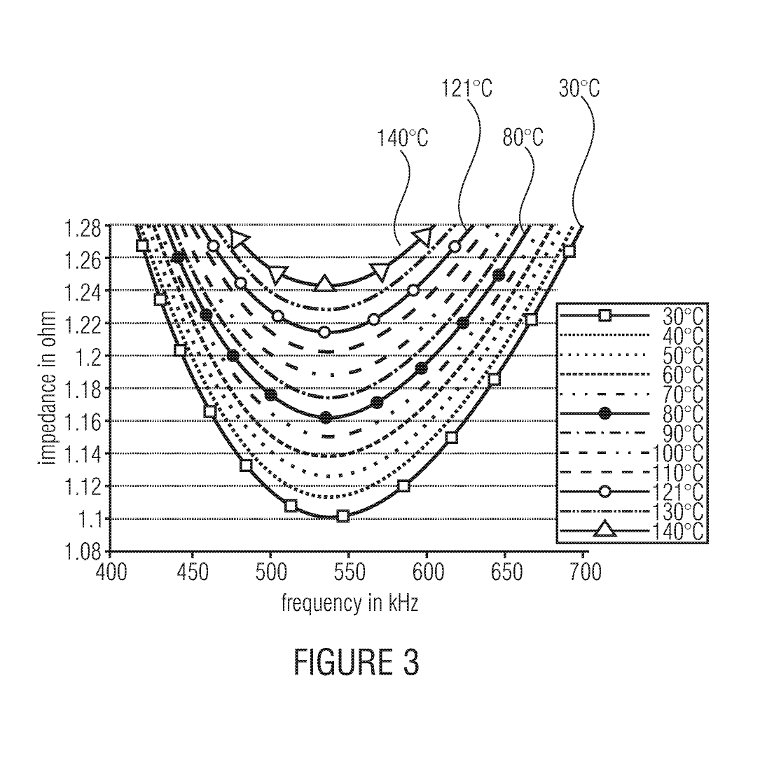

FIG. 3 exemplarily shows a diagram of an impedance between a gate terminal 108 of an IGBT 102 and an emitter terminal 110 of the IGBT 102 as a function of the frequency of an alternating voltage applied to the IGBT 102, for 12 different temperatures from 30° C. to 140° C. The ordinate here describes the impedance in ohm and the abscissa describes the frequency in kHz.

It may be recognized from FIG. 3 that the impedance between the gate terminal 108 of the IGBT 102 and the emitter terminal 110 of the IGBT 102 increases with an increasing temperature. This may be attributed to the temperature dependence of the integrated gate resistor 112. Additionally, it may, for example, be recognized from FIG. 3 that the impedance exhibits a minimum at approx. 540 kHz, corresponding to the resonant frequency which is defined by the capacitive and/or inductive portions. In the impedance minimum, the magnitude of the impedance thus equals the gate resistance 112 to be measured plus the feed resistances. The impedance, which is proportional to the temperature, may be determined using the current intensity measured. Thus, the quantity desired, namely the barrier layer temperature, has been determined. In accordance with the present invention, the alternating voltage is thus used for measuring the gate resistance 112.

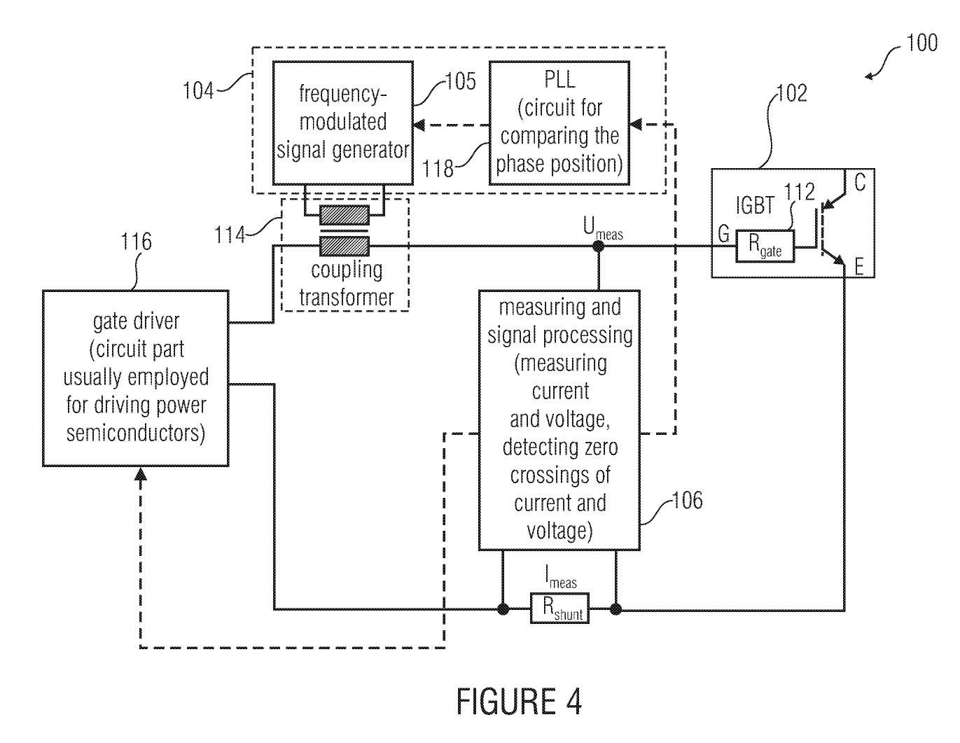

FIG. 4 shows a block circuit diagram of a device 100 for measuring the temperature of a power semiconductor 102 in accordance with an embodiment of the present invention. The device 100 comprises means 104 for applying an alternating voltage to the power semiconductor 102 and means 106 for measuring an impedance between a control terminal 108 of the power semiconductor 102 and a channel terminal 110 of the power semiconductor 102, the impedance being dependent on a temperature-dependent control resistor 112 integrated in the power semiconductor 102.

In FIG. 4, the power semiconductor 102 is, for example, an IGBT 102, the control terminal 108 being a gate terminal 108 and the channel terminal 110 being an emitter terminal 110. However, the invention is not restricted to such embodiments, but rather the power semiconductor 102 may be any power semiconductor 102 which comprises an integrated temperature-dependent control resistor 112.

In embodiments, the means 104 for applying the alternating voltage may comprise a frequency-modulated signal generator 105 configured to generate the alternating voltage. Additionally, the means 104 for applying the alternating voltage may be configured to apply the alternating voltage between the control terminal 108 of the power semiconductor 102 and the channel terminal 110 of the power semiconductor 102. Thus, the means 104 for applying the alternating voltage may be coupled to the control terminal 108 of the power semiconductor 102 and the channel terminal 110 of the power semiconductor 102 via a potential level changing circuit 114. The potential level changing circuit may be of an inductive coupling type, such as, for example, of a transformer coupling type.

In order to determine the impedance between the control terminal 108 of the power semiconductor 102 and the channel terminal 110 of the power semiconductor 102, the means for measuring the impedance may also be coupled to the control terminal 108 of the power semiconductor 102 and the channel terminal 110 of the power semiconductor 102a, wherein the means 106 for measuring the impedance may be configured to measure the impedance between the control terminal 108 of the power semiconductor 102 and the channel terminal 110 of the power semiconductor 102 based on a voltage measurement of a voltage between the control terminal 108 of the power semiconductor 102 and the channel terminal 110 of the power semiconductor 102 and a current measurement of a current flowing through the impedance between the control terminal 108 of the power semiconductor 102 and the channel terminal 110 of the power semiconductor 102. For measuring the current, the means 106 for measuring the impedance may comprise a measuring resistor Rₛₕᵤₙₜ and be configured to measure the voltage drop across the known measuring resistor Rₛₕᵤₙₜ which is proportional to the current flowing through the integrated temperature-dependent control resistor 112.

The means 104 for applying the alternating voltage may additionally be configured to select, based on the voltage and the current, the frequency of the alternating voltage such that capacitive and/or inductive portions of the measurement are reduced. Exemplarily, the means 104 for applying the alternating voltage may be configured to determine a phase difference between the current and the voltage to select, based on the phase difference, the frequency of the alternating voltage such that the phase difference between the voltage and the current is reduced. When the phase difference between the voltage and the current is zero, the frequency of the alternating voltage will correspond to the resonant frequency defined by the capacitive and/or inductive portions. With the resonant frequency, the capacitive and inductive portions of the impedance cancel each other out so that the impedance corresponds to the temperature-dependent control resistance 112 plus the feed resistances.

In order to reduce the phase difference between the current and the voltage, the means 104 for applying the alternating voltage may comprise comparing means 118 configured to provide phase information describing a phase difference between the voltage and the current, the means 104 for applying the alternating voltage being configured to select the frequency of the alternating voltage based on the phase information. The comparing means may, for example, be a PLL (phase locked loop). Using the PLL, the impedance minimum may be detected since, with this frequency, the current and the voltage of the high-frequency signal are in phase.

In inverters, the power semiconductor 102 is usually driven by the control voltage of a driver circuit 116, wherein the power semiconductor 102 is either in an on state or an off state, depending on the control voltage applied to the control terminal 108 of the power semiconductor 102.

In order to allow precise measurement of the impedance between the control terminal 108 of the power semiconductor 102 and the channel terminal 110 of the power semiconductor 102, it is of advantage for the power semiconductor 102 to be in a stationary state. The stationary state may, for example, be a settled on state. The means 106 for measuring the impedance may thus be configured to determine a period of time in which the power semiconductor 102 is in a stationary state, and to measure the impedance during the period of time in which the power semiconductor 102 is in the stationary state. The stationary state may be determined based on the voltage and/or the current.

The switching frequency of the power semiconductor 102 usually is in the range of some 10 Hz to some 10 kHz, whereas the resonant frequency which is defined by the capacitive and/or inductive portions is in the range of some 100 kHz. Thus, the period of time between two subsequent switching processes in which the power semiconductor 102 is in a quasi-stationary state may be used to measure the impedance of the integrated temperature-dependent control resistor 112 and determine the temperature of the power semiconductor 102.

In addition, the means 106 for measuring the impedance may be configured to acquire switching information of the driver circuit 116 and to determine, based on the switching information of the driver circuit 116, the period of time during which the power semiconductor 102 is in the stationary state. The switching information may exemplarily be a binary control signal or drive signal applied to the driver circuit 116, based on which the driver circuit 116 provides the control voltage for the power semiconductor 102.

Additionally, the means 104 for applying the alternating voltage may be configured to acquire information describing the period of time during which the power semiconductor 102 is in the stationary state, and to apply the alternating voltage to the power semiconductor 102, based on the information, during the period of time in which the power semiconductor 102 is in the stationary state. This allows ensuring the alternating voltage not to be applied to the power semiconductor 102 during the process of switching on and off.

Furthermore, in embodiments, measuring the temperature allows drawing conclusions as to the physical state, such as, for example, the state of aging, of the power semiconductor 102. Exemplarily, the power semiconductor 102 will exhibit a higher temperature at equal power loss if cracks have formed in the solder layer.

Further embodiments of the present invention relate to a method of measuring a temperature of a power semiconductor. In a first step, an alternating voltage is applied to the power semiconductor. In a second step, an impedance between the control terminal of the power semiconductor and the channel terminal of the power semiconductor is measured, the impedance being dependent on a temperature-dependent control resistor integrated in the power semiconductor.

Although some aspects have been described in connection with a device, it is to be understood that these aspects also represent a description of the corresponding method such that a block or element of a device is also to be understood to be a corresponding method step or a characteristic of a method step. In analogy, aspects which have been described in connection with a method step, or as a method step, also represent a description of a corresponding block or detail or characteristic of a corresponding device. Some or all the method steps may be executed by a hardware apparatus (or using a hardware apparatus), such as, for example, a microprocessor, a programmable computer or an electronic circuit. In some embodiments, some or several of the most important method steps may be executed by such an apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A device for measuring a temperature of a power semiconductor, comprising:
an applier for applying an alternating voltage to the power semiconductor; and
a measurer for measuring an impedance between the control terminal of the power semiconductor and the channel terminal of the power semiconductor, the impedance being dependent on a temperature-dependent control resistor integrated in the power semiconductor;
wherein the applier for applying the alternating voltage is configured to select a frequency of the alternating voltage such that capacitive and/or inductive portions of the measurement are reduced, and such that the frequency is in a range of a resonant frequency defined by the capacitive and/or inductive portions.

2. The device in accordance with claim 1, wherein the capacitive portions comprise capacities of the power semiconductor, and wherein the inductive portions comprise inductivities of the power semiconductor.

3. The device in accordance with claim 1, wherein the capacitive portions comprise capacities of the applier for applying the alternating voltage and/or the measurer for measuring the impedance, and wherein the inductive portions comprise inductivities of the applier for applying the alternating voltage and/or the measurer for measuring the impedance.

4. The device in accordance with claim 1, wherein the applier for applying the alternating voltage is configured to apply the alternating voltage between the control terminal of the power semiconductor and the channel terminal of the power semiconductor.

5. The device in accordance with claim 4, wherein the applier for applying the alternating voltage is coupled to the control terminal of the power semiconductor and the channel terminal of the power semiconductor via a potential level changing circuit.

6. The device in accordance with claim 1, wherein the measurer for measuring the impedance is configured to determine the temperature of the power semiconductor based on the impedance.

7. The device in accordance with claim 6, wherein the measurer for measuring the impedance is configured to determine the temperature of the power semiconductor based on a real part of the impedance.

8. The device in accordance with claim 1, wherein the measurer for measuring the impedance is configured to measure the impedance between the control terminal of the power semiconductor and the channel terminal of the power semiconductor based on a voltage measurement of a voltage between the control terminal of the power semiconductor and the channel terminal of the power semiconductor and a current measurement of a current flowing through the impedance between the control terminal of the power semiconductor and the channel terminal of the power semiconductor.

9. The device in accordance with claim 8, wherein the applier for applying the alternating voltage is configured to select, based on the voltage and the current, the frequency of the alternating voltage such that capacitive and/or inductive portions of the measurement are reduced.

10. The device in accordance with claim 8, wherein the applier for applying the alternating voltage comprises a comparer configured to provide phase information describing a phase difference between the voltage and the current, the applier for applying the alternating voltage being configured to select the frequency of the alternating voltage based on the phase information.

11. The device in accordance with claim 1, wherein the measurer for measuring the impedance is configured to determine a period of time during which the power semiconductor is in a stationary state, and measure the impedance during the period of time.

12. The device in accordance with claim 11, wherein the measurer for measuring the impedance is configured to acquire switching information of a driver circuit of the power semiconductor, and to determine, based on the switching information of the driver circuit, the period of time during which the power semiconductor is in the stationary state.

13. The device in accordance with claim 11, wherein the applier for applying the alternating voltage is configured to acquire information describing the period of time during which the power semiconductor is in the stationary state, and to apply the alternating voltage to the power semiconductor, based on the information, during the period of time.

14. A method of measuring a temperature of a power semiconductor, comprising:
applying an alternating voltage to the power semiconductor; and
measuring an impedance between the control terminal of the power semiconductor and the channel terminal of the power semiconductor, the impedance being dependent on a temperature-dependent control resistor integrated in the power semiconductor;
wherein, when measuring the impedance, a frequency of the alternating voltage is selected such that capacitive and/or inductive portions of the measurement are reduced, and such that the frequency is in a range of a resonant frequency which is defined by the capacitive and/or inductive portions.

15. The method in accordance with claim 14, further comprising:
determining a physical state of the power semiconductor based on the measurement of the temperature.
